(19) United States
(12) Patent Application Publication
(10) Pub. No.: US 2019/0378088 A1
(43) Pub. Date: Dec. 12, 2019

(54) SYSTEM AND METHOD OF INDIVIDUALIZED MERCHANDISING IN AN AUTOMATIC RETAIL DEVICE

(71) Applicant: VIATOUCH MEDIA INC., New York, NY (US)

(72) Inventors: James Winsor, Riverside, CA (US); Robert Hurtado, Corona, CA (US); Milan Alvarado, Riverside, CA (US); Thomas Murn, San Diego, CA (US)

(21) Appl. No.: 16/483,358

(22) PCT Filed: Feb. 2, 2018
(86) PCT No.: PCT/US18/16619

§ 371 Date: Aug. 2, 2019

Related U.S. Application Data
(60) Provisional application No. 62/454,692, filed on Feb. 3, 2017.
(60) Provisional application No. 62/454,690, filed on Feb. 3, 2017.

(51) Int. Cl. G06Q 10/08; G07F 9/02

(52) U.S. Cl. CPC G06Q 10/0875; G07F 9/026; G07F 9/023

(57) ABSTRACT

A system and method of stocking an automatic retail device including receiving seller identification information of a seller including financial institution information of the seller, receiving proposed product information of a product to be offered for sale by the seller, assigning a lease space in the automatic retail device for stocking of the product, determining whether the assigned leased space in the automatic retail device is available, acquiring product information of the product using the automatic retail device, and indicating a location of the leased space in the automatic retail device for stocking the product. The proposed information of the product may include a description of the product, a size of the product, or a weight of the product. The acquired product information may include an image of the product or a weight of the product.

### CROSS-REFERENCE TO RELATED APPLICATIONS

The present disclosure claims the benefit of and priority to U.S. Provisional Patent Application Ser. No. 62/454,690, filed on Feb. 3, 2017 and U.S. Provisional Patent Application Ser. No. 62/454,692, filed on Feb. 3, 2017, the entire contents of each of which are incorporated herein by reference. The present disclosure is related to U.S. patent application Ser. No. 14/947,848, filed on Nov. 20, 2015; and International Patent Application Serial No. PCT/US2017/066190, filed on Dec. 13, 2017, which claims priority to U.S. Provisional Patent Application Ser. No. 62/433,464, filed on Dec. 13, 2016, the entire contents of each of which are incorporated herein by reference.

### BACKGROUND

### 1. Technical Filed

The present disclosure is directed to a system and method for stocking an automatic retail device. In particular, the present disclosure is directed to a system and method for tracking chain of custody of products for sale in an automatic retail device and enabling small scale manufacturers and sellers, so called makers, to have an opportunity to make their wares available for sale or pickup through an automatic retail device.

### 2. Description of Related Art

Prior automatic retail devices and networked vending systems have been described in the following commonly-owned references: U.S. Pat. No. 8,191,779, entitled Wireless Management of Remote Vending Machines; U.S. Pat. No. 8,998,082, entitled Multimedia System and Methods for Controlling Vending Machines; U.S. Patent Application Publication No. 2015/0279147, entitled, Systems and Methods for Automated Dispensing Systems in Retail Locations, filed Mar. 31, 2015; and U.S. Patent Application Publication No. 2017/0148005, entitled Integrated Automatic Retail System and Method, filed Nov. 20, 2015. Each of these patents and U.S. Publications are incorporated herein by reference.

In the last 10-15 years there has been a great influx in demand for hand-made unique items. Indeed, there is a market leader for the sale of these types of goods, ETSY®. On this site, makers, manufacturers, and producers of all sorts (also referred to herein as “sellers”) are able to market and sell their unique goods to the world. However, even if this produces a market place, and orders come in, the maker must still perform all the tasks of labeling, shipping, receiving payment, etc. Because of the cost of retail space, the maker is limited in how goods can be made available to the consumer. Further, heretofore, the types of goods the typical maker would produce were not amenable to sale through a standard vending machine or automatic retail device due to the good's unique characteristics and variations in size and weight.

The present disclosure provides an avenue for a maker or small producer to have dedicated micro-market retail space for the sale of their goods. Further, one of the benefits of the system of the present disclosure is that it requires no dedicated personnel to be present with the goods for sale.

### SUMMARY

The present disclosure is directed to a method of stocking an automatic retail device including receiving seller identification information of a seller including financial institution information of the seller, receiving proposed product information of a product to be offered for sale by the seller, assigning a lease space in the automatic retail device for stocking of the product, determining whether the assigned leased space in the automatic retail device is available, acquiring product information of the product using the automatic retail device, and indicating a location of the leased space in the automatic retail device for stocking the product. The proposed information of the product may include a description of the product, a size of the product, or a weight of the product. The acquired product information may include an image of the product or a weight of the product.

In an aspect, the method further includes calculating a cost for the assigned lease space based on at least one of a size of the leased space, a location of the leased space, or a location of the automatic retail device. A new lease space may be detected and assigned when it is determined that the assigned leased space is not available or otherwise currently taken up by another item. In an aspect, when it is determined that the assigned leased space is not available, the method may further include determining whether the seller of the goods stocked in the leased space is in default of payment for the leased space. When it is determined that the seller is in default of payment for the leased space, the method may further include removing the items offered for sale by the seller in default and storing those items for pickup by the seller in default in a repository of the automatic retail device.

In an aspect, acquiring product information of the product using the automatic retail device includes capturing an image of the product using a camera of the automatic retail device or acquiring a weight of the product using a scale of the automatic retail device.

The location of the leased space within the automatic retail device for stocking of the products may be indicated by illuminating a bin corresponding to the leased space, prompting an audible notification identifying the leased space, prompting a tactile vibration of a bin corresponding to the leased space, or any combinations thereof.

In an aspect, upon completion of stocking the items in the leased space, the stocking event information may be reported to a server. Additionally, or alternatively, the method may further include determining if an item stocked in the automatic retail device has been removed from the automatic retail device and confirming whether a purchase is desired when it is determined that an item has been removed from the automatic retail device. In an aspect, it is determined that an item stocked in the automatic retail device has been removed from the automatic retailed device when a weight of a bin in the automatic retail device is changed after access to the automatic retail device is granted or when an image of a bin in the automatic retail device reveals that an item has been removed from the bin after access to the automatic retail device is granted.

The leased space may include a single bin of the automatic retail device configured to stock multiple items of varying size or a plurality of bins, where each bin is configured to store a single item therein.

### BRIEF DESCRIPTION OF THE FIGURES

FIG. 1 is a front view of an automatic retail device in accordance with the present disclosure;

FIG. 1A is a front perspective view of a portion of the automatic retail device of FIG. 1; FIG. 2 is a system architecture diagram of an automatic retail system in accordance with the present disclosure;

FIG. 3A is a front perspective view of an exemplary bin for use with the automatic retail device of FIG. 1;

FIG. 3B is a top perspective view of the bin of FIG. 3A;

FIG. 3C is a side view of the bin of FIG. 3A; and

FIG. 4 is an exemplary workflow of a method for stocking the automatic retail device of FIG. 1.

### DETAILED DESCRIPTION

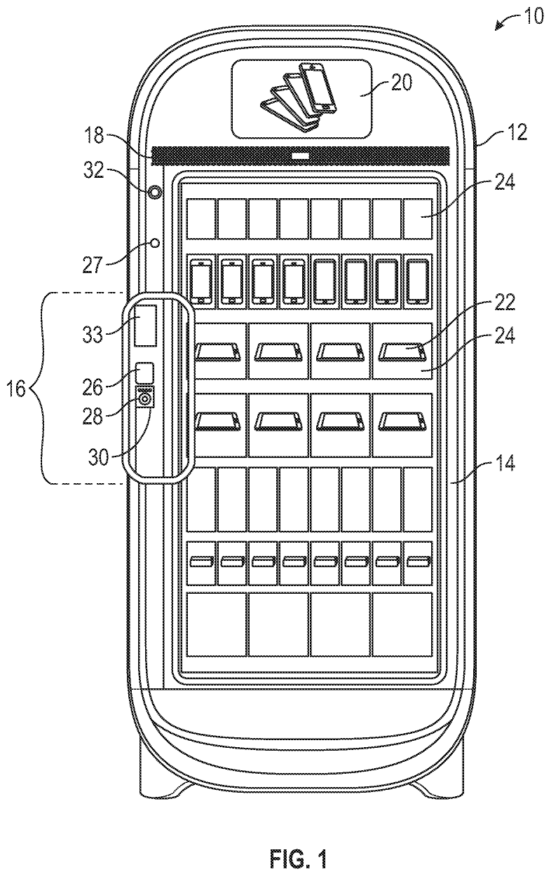

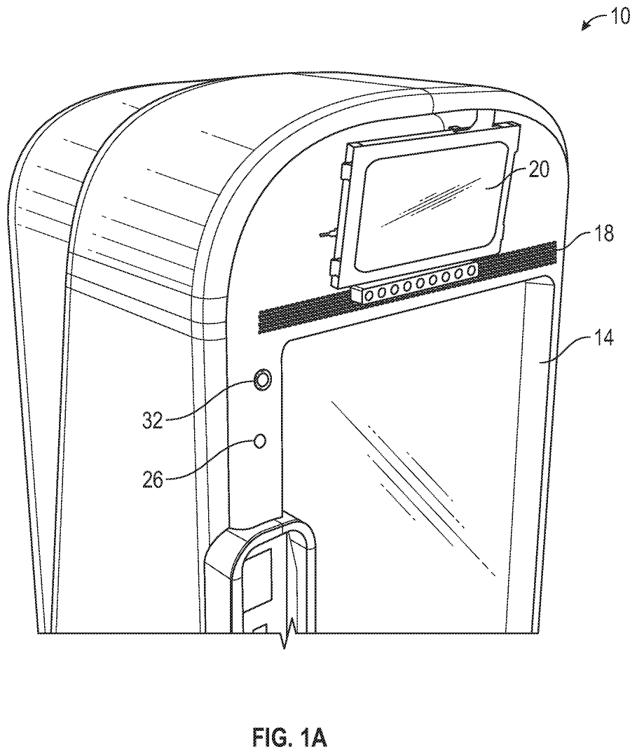

FIG. 1 depicts an automatic retail device 10 in accordance with the present disclosure. The automatic retail device 10 includes an enclosure 12 having a door 14. The door 14 employs a locking mechanism 16 to limit access to the automatic retail device 10. The soundbar 18 outputs audible information to a user at the automatic retail device 10. The soundbar 18 also incorporates a speaker and a microphone which receives verbal communication from a user. A display 20 outputs visual information to a user at the automatic retail device 10. The door 14 preferably has a glass front 22 allowing a user to see all that is retained within the automatic retail device 10.

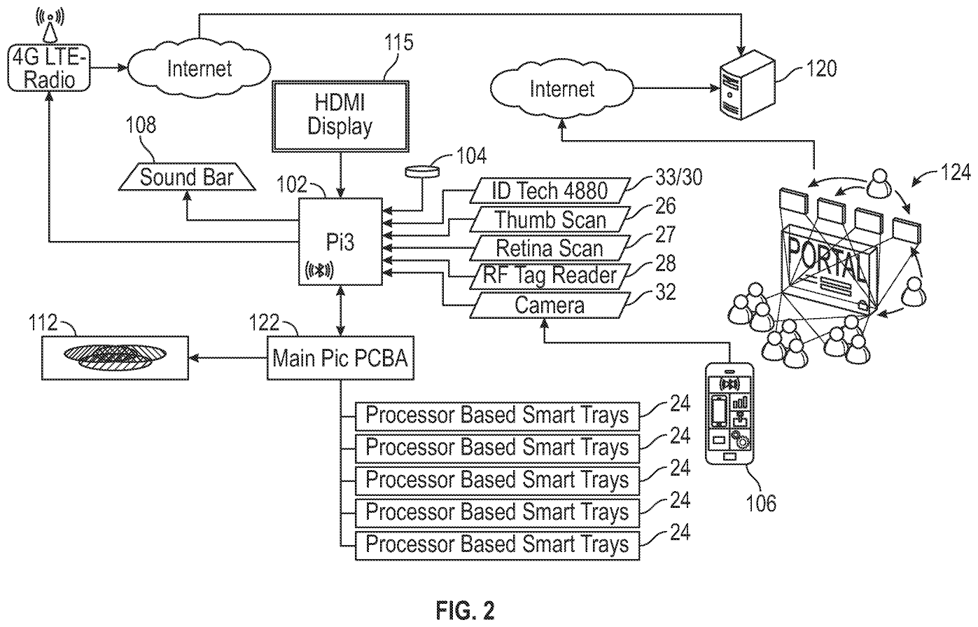

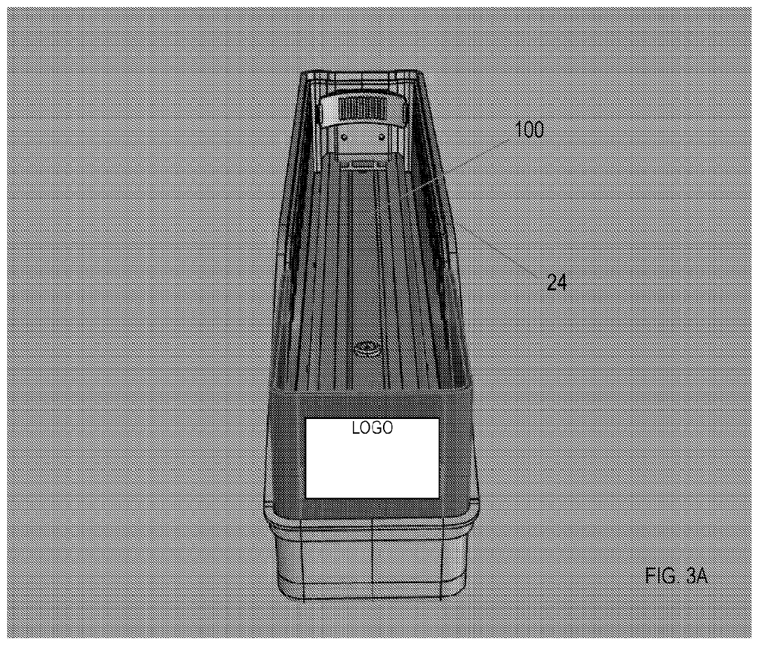

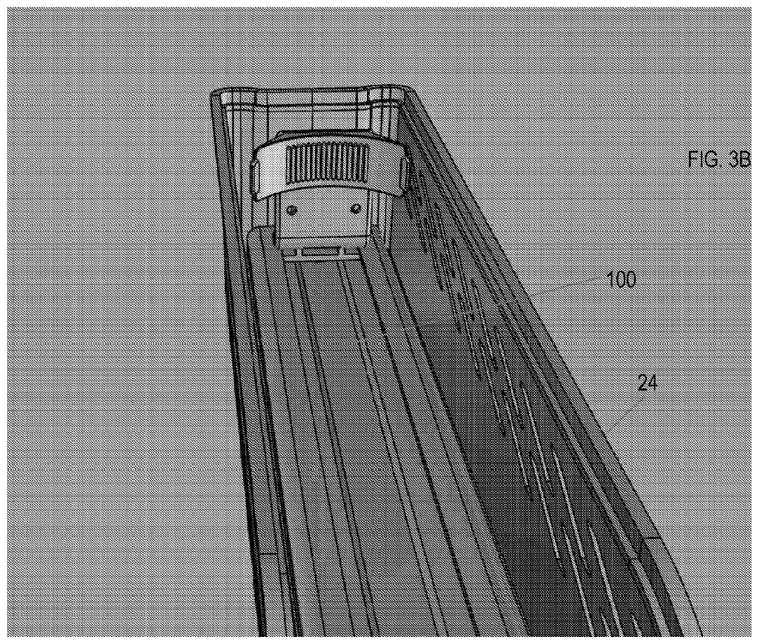

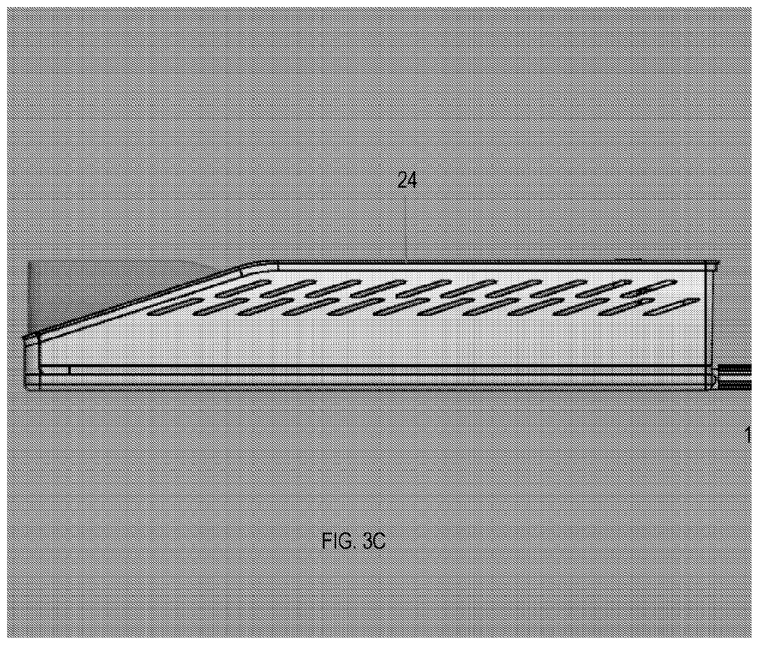

In this embodiment, the glass front 22 reveals what appear to be shelves including a variety of bins 24. In fact, each bin 24 is individually mounted to a back wall of the automatic retail device 10 via a load bar (FIGS. 3A-3C) and rail, and a wide variety of different sized bins 24 can be interchangeably employed depending on the articles to be vended. The bins 24 are configured to house, or otherwise support, different products ranging in a variety of different sizes and weights, as such a variation is typical among items offered for sale by sellers of unique and handmade products. Each bin 24, which is dimensioned to support a variety of products of different sizes and weights, is configured to couple to a load bar 100. Further details regarding the load bar 100 and the bins 24 may be found in U.S. Provisional Patent Application Ser. No. 62/454,551, filed on Feb. 3, 2017, U.S. Provisional Patent Application Ser. No. 62/536,811, filed on Jul. 25, 2017, U.S. Provisional Patent Application Ser. No. 62/586,659, filed on Nov. 15, 2017, and U.S. Patent Application Ser. No ______, filed concurrently herewith, the entire contents of which are incorporated herein by reference. In one aspect, each load bar 100 of the automatic retail device 10 is configured to support a plurality of bins 24. In this configuration, each bin 24 can be associated with a single product positioned therein. Alternatively, in another aspect, each load bar 100 of the automatic retail device 10 is configured to support a single bin 24, where the single bin 24 is associated with a plurality of products (or a single product) positioned therein. The bin 24 may consist of a metal stamped base which houses a semi-translucent plastic bin. The bin 24 includes a single load cell for connecting to the load bar 100 when the bin 24 is coupled to the load bar 100.

The locking mechanism 16 of automatic retail device 10 may include a variety of features that can be interchangeably, or in combination, used to permit or limit access to the interior of the automatic retail device 10. For example, a biometric identifier (e.g., thumbprint reader) 26 may be incorporated into the locking mechanism 16. Alternatively or additionally, the biometric reader 26 may be an iris scanner. Further, a near field communication (NFC) reader 28 may be incorporated into the locking mechanism 16, which is used to communicate with another NFC enabled device (e.g., most smartphones operating applications such as APPLE PAY® or ANDROID PAY®). Additionally or alternatively, the NFC reader 28 may be an RFID reader and may be employed to detect the presence of an RFID tag. Still further, a card reader 30 may be utilized and permit access to the automatic retail device 10 only after swiping or reading of the chip on a credit card. Still further, a facial recognition camera 32 may be employed to detect a user as they approach the automatic retail device 10. Finally, a key pad 33 (either physical or a touch screen) to enable the inputting of pin codes or promotion codes and the like may further be coupled to and/or incorporated in the locking mechanism 16, as will be described in greater detail below. The keypad or touchscreen 33 may also be used to enable responses by the user (e.g., selection of an option, presentation of branding associated with a product or service, or it may flash to alert the user of its location). Not shown in FIG. 1 are one or more further cameras located on the interior of the automatic retail device 10, these may be positioned on the interior of the door 14, or on certain bins 24 to enable filming/recording of user actions and user identification when retrieving items from the automatic retail device 10. For further details regarding the automatic retail device 10, reference is made to International Patent Application No. PCT/US2017/066190, entitled “Methods and Utilities for Consumer Interaction with a Self Service System,” filed Dec. 13, 2017, the entire contents of which are incorporated herein by reference.

The term “user” as used herein refers to any type of user of an automatic retail device 10, including purchasers, sellers, stockers, maintenance repair personnel, or any other type of user of such system, and such references are used interchangeably herein. Any of the inputs from a user or seller may be used to permit access to the goods and products kept within the automatic retail device 10 or to gain access to the shelving or bins 24 of the automatic retail device 10 to stock products therein. In order for a seller of products to access the automatic retail device 10 to stock their products therein, a seller may set up an account through an application (not shown) that can be downloaded to the user's smartphone or accessed through a web-based system using a computer, tablet, or other web-enabled device, as will be described in greater detail below. In summary, the seller inputs their information, including a credit card number, debit card number or other payment information in addition to financial information for which funds will be transferred upon completion of a sale. During this process, the seller may be requested to take a photo of themself, provide a thumb or finger print, submit a voice sample, or simply provide a pin number. Most smartphones include means for collecting images, finger or thumbprints, and voice samples, and can be configured to conduct an iris scan using the resident imaging capabilities. This information is collected and transmitted in encrypted form to servers that house the information for future use, as will be described in greater detail below.

The automatic retail device 10 may have an architecture as depicted in FIG. 2. The automatic retail device 10 includes a microcontroller 102 which receives input from a variety of the components described above, including a microphone 104, a card reader/touchscreen 30/33, a fingerprint scanner 26, a retina scanner 27, and RFID tag reader (e.g., a NFC device) 28, and/or a camera 32. A display screen 20 also receives input from the microcontroller 102. Still further, the microcontroller 102 may be enabled to receive communications directly from a smartphone 106 via, for example, BLUETOOTH® and other wireless communication protocols. The microcontroller 102 also provides outputs to the speakers 108, and to a wireless internet connection 110, such as 4G LTE or other cellular or wireless communications systems, to enable internet connectivity. The internet connectivity allows for communications over the internet for a variety of purposes, as described in greater detail below. The microcontroller 102 also controls the locking mechanism 16 of the automatic retail device 10.

The locking mechanism 16, and particularly the fingerprint scanner 26, NFC device 28, or card reader 33 can include a lighting mechanism whereby a light pipe or other light source projects backlighting onto a rear surface of these interfaces. This may be a Red, Green, Blue type backlighting arrangement. This backlighting allows the user to request indication of which interface is for which type of payment and have the automatic retail device 10 light the appropriate one in response to the request.

The microcontroller 102 is primarily responsible for receiving inputs from a user and communicating with the system servers 120 to confirm the identity of the user, control stocking and inventory, and permit access to the automatic retail device 10. In connection with the confirmation of the identity of the user, a variety of protocols may be initiated. Upon receiving an input from a user to authorize access to the automatic retail device, the microcontroller 102 may signal the main controller 122 to survey the contents of the automatic retail device 10. This may be done by weighing each bin 24 of the automatic retail device 10. As noted above, these bins 24 can be installed in a variety of configurations to accommodate different items. Further, the main controller 122 and/or the microcontroller 102 may have access to a planogram outlining the contents of each bin 24 and the per-item weights of each item to be stocked in the automatic retail device 10. The planogram may be saved in memory associated with the main controller 122 and the microcontroller 102. As a result of this data, which is stored in a form accessible by the main controller 122 and the microcontroller 102, immediately before the unlocking of the door of the automatic retail device 10, a survey may be conducted to determine the contents of each individual bin 24 contained within the automatic retail device 10. While the contents of the survey of the automatic retail device 10 are being determined, the information provided by the user, e.g., the biometric data or RFID tag data or image, is transmitted to the servers 120 for confirmation of the user's identity. The servers 120 transmit a signal either confirming the user's identity and granting access or denying access to the automatic retail device 10. With the contents of the automatic retail device 10 confirmed, and the identity of the user confirmed, the microcontroller 102 can output a signal to the locking mechanism 16 to allow the door 14 to be opened.

As described briefly above, a user may create a user account using an application on their smartphone 106. Alternatively, the user may avail themselves of a client portal 124 via a web connected device and create an account granting the user access to the automatic retail device 10. The user interface allows the user to enter the necessary identifying information and provide the biometric samples (e.g., iris scan, photo, voice sample, thump print, etc.). In addition, the client portal 124 allows the user to check their account balances, alter payment arrangements, and challenge charges to their account.

As an alternative to, or in addition to, the app or the client portal 124, the user may go through an account set-up process at the automatic retail device 10. The interactions with the automatic retail device 10 may be supported by an artificial intelligence (AI) that is either resident on the automatic retail device 10 or in close communication via the internet connection 110 (e.g., on a server 120). An AI in its simplest form is a combination of computer programs that can receive different inputs and respond audibly, physically, or visually using the soundbar 18, the display 20, the lighting 112 and other features of the automatic retail device 10. Often, the AI is primarily a translator from speech to text to data enabling the microcontroller 102 to analyze the data and formulate a response or to communicate further to the server 120 via the internet connection 110 to resolve the communication, receive a return of data from the server 120 and again translate that to a form the user can understand. That translation may be audible using the soundbar 18, it may be visual using the display 20, it may include lighting 112, and other forms of communication.

In the example of setting up an account at the automatic retail device 10, after inserting a credit card, the AI associated with the automatic retail device 10 walks the user through a series of questions and queries to set up the account. For example, having read the information on the credit card, the AI using the soundbar 18 may communicate directly with the user asking if they would like to set up an account. When the user says yes, the AI may ask that the user confirm their name, and provide some additional information to corroborate their identity. Once corroborated, the AI may request the user place their finger or eye on or near the biometric reader. The data related to user's biometrics are stored and will be forwarded to the servers 120 and databases that house the information of all the users. The AI may also take an image of the user and associate that image with the account. Still further, a voice sample may be recovered for comparison purposes in future transactions. This may take the form of a request for verbal confirmation that the user wishes to agree to the terms of use of the automatic retail device 10.

Once all the data is collected, anything removed by that user from the automatic retail device 10 will be charged to the user's credit card or otherwise reconciled as set out in the agreement with the automatic retail device 10 system. In one embodiment, none of the data regarding the user is saved locally on the automatic retail device 10, but rather is uploaded in an encrypted form to the servers 120 for access at later time. In effect, this action at the automatic retail device 10 is identical to the outcome achieved using either an app. on a smartphone 117 to set up an account, or using the client portal 124.

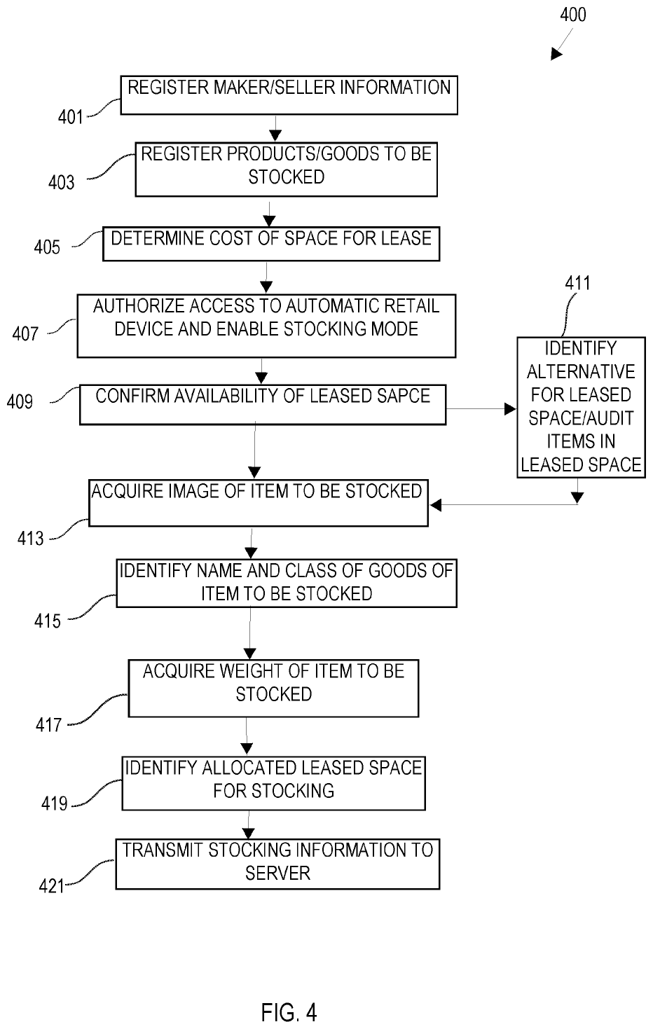

In accordance with one aspect of the present disclosure, there is provided an application for a smartphone either alone or in conjunction with web app or website, where a seller can register to lease space in an automatic retail device 10. As part of this set-up and with reference to method 400 of FIG. 4, in step 401, the seller must provide some financial institution information so that debits for fees accrued by the seller can be made from the financial institution and so that deposits for the sale of goods can be made to the financial institution. This may also include, in step 403, a description of their goods and the amount of space required to make one or more of these items available for sale. Depending on the size of the goods and other factors, in step 405, an agreement can be reached on the cost of a lease of space for the seller in one or more automatic retail devices 10. As will be apparent, the cost may depend on the amount of space requested and needed for the goods being sold. Once agreed to, the seller is granted access to the automatic retail device 10 of their choice that has space available. As will be appreciated, the cost of space, like all real estate, may also depend on the location of the automatic retail device 10 selected and the location of the shelf space within the automatic retail device 10 itself. In this way, a location in a desirable high traffic or high sales location may be more costly than one that has more modest sales. Additionally, a shelf location which is closer to average eye-level within the automatic retail device 10 may be more costly than a shelf location which is below or above average eye-level.

Once in the system, the seller is able to proceed to the location or locations they have leased and begin stocking the goods and making their goods available for sale. In one aspect, the registration into the system may be accomplished at the automatic retail device 10 itself. One aspect of the system is keeping an accurate planogram or goods offered at each location. Because the items most sellers offer are unique, the planogram is created only after the unique items are stocked (and imaged) in the automatic retail device 10.

Upon arrival and processing of biometric or other data enabling access, in step 407, the automatic retail device 10 will go into a stocking mode. In the stocking mode, as a first step, an inventory of the goods already in the automatic retail device 10 will be undertaken. In this process (step 409), the automatic retail device 10 will confirm that the space that has been leased by the seller is indeed empty and available for use. If it is determined that the space leased by the seller is not available for use (no in step 409), then an error is identified and, working with the resident Artificial Intelligence (AI), the system can resolve the issue (step 411). For example, the issue may be resolved by identifying other space that is currently available and which meets the seller's needs or by confirming that the goods remaining on the leased shelves have been foreclosed on due to non-payment of lease and thus may be removed, discarded, or placed in a repository for the lessor of the automatic retail device 10 space to collect.

When the shelves identified as empty and leased by the seller are available (yes in step 409), a workflow commences whereby a single one of the seller's goods is first imaged using one or more of the cameras 32 associated with the automatic retail device 10 (step 413). Second, in step 415, if not previously done, the name, type, or class of goods may be identified. Finally, in step 417, a single item may be placed on the weight sensitive shelves so that an accurate weight of a single item can be determined. Because often the items for sale by sellers will vary in weight and size (even when marked with the same SKU), this process may require movement of the items to several locations or the addition of several similar items to allow for some tolerance range in weight for the goods. Having determined the weight of one item (and possibly more), in step 419, the seller is able to stock their allocated shelves with their goods.

In step 419, the allocated shelves may have been highlighted by the automatic retail device 10 verbally using the AI (through soundbar 18), visually using lights associated with the bins 24, tactically using vibration of a motor associated with the bins 24, and other methods. Once placed, the seller may indicate on their app on their smartphone that their stocking is complete, or simply close the door at which time the AI may ask if stocking is complete. Alternatively, if the seller simply walks away, the door will lock within a specified time of no response.

In step 421, once the stocking of the products on the shelves is complete, the automatic retail device 10 transmits a completed stocking event to the servers 120 and updates the planograms accordingly to identify the weights of the goods and other distinguishing features and sales can now commence from that location. The seller may add the location of the automatic retail device 10 stocked with their products to his or her marketing efforts. Payment for sale of goods is received into an account for the seller from the proprietor of the automatic retail device 10.

If during the time that the door is open and the seller is stocking his own shelves, he removes another item from a shelf, the AI may alert the seller that this action has been detected and request audible confirmation that the seller intends to purchase the product. Regardless of the response, upon closure and locking of the door the seller will be charged for the good if not returned to the appropriate shelf.

As with other merchandising, upon sensing a possible completion of merchandising the AI may audibly request the seller confirm that stocking is complete or the seller may indicate such using the app.

In some instances, having weighed a single item and knowing its general specifications, an allotment of items the seller may place on the shelf may be identified. While this number had not been reached, the shelf may be illuminated in red, and upon achieving the number, the shelf may turn green indicating that the seller is done with stocking and has reached the quota.

The application may alert the seller each time that an item is purchased, and also send an alert when the inventory has reached a certain level so that the item may be restocked. The system can reconcile payment with the purchaser for the goods purchased.

In the references incorporated herein, there are described a variety of vending or automatic retail device systems. These systems offer secure storage of goods, limited and verified access, multiple monitoring vectors including AI, cameras, biometrics, voice confirmation, thumb print scanning, iris scanning, and credit card processing, and remote monitoring, inventory control, payment processing and other factors of all of the above. Through these systems, as described in these applications and patents, highly finite control of every product placed in, or taken out of, the automatic retail device can be undertaken and pilfering essentially eliminated. Further, resolution of purchase disputes can be eliminated by an overwhelming amount of information available about every transaction and every lifting of a good off of the weight sensitive shelves.

1. A method of stocking an automatic retail device, the method comprising:
receiving seller identification information of a seller including financial institution information of the seller;
receiving proposed product information of a product to be offered for sale by the seller including at least one of a description of the product, a size of the product, or a weight of the product;
assigning a lease space in the automatic retail device for stocking of the product;
determining whether the assigned leased space in the automatic retail device is available;
acquiring product information of the product using the automatic retail device, the acquired product information including at least one of an image of the product or a weight of the product; and
indicating a location of the leased space in the automatic retail device for stocking the product.

2. The method of claim 1, further comprising calculating a cost for the assigned lease space based on at least one of a size of the leased space, a location of the leased space, or a location of the automatic retail device.

3. The method of claim 1, further comprising determining whether the assigned leased space in the automatic retail device is available and reassigning a new lease space in the automatic retail device when it is determined that the leased space is not available.

4. The method of claim 1, further comprising:
determining whether the assigned leased space in the automatic retail device is available;
determining that the leased space is not available when items offered for sale by another seller are located in the leased space;
determining whether the another seller is in default of payment for the leased space; and
removing the items offered for sale by another seller when it is determined that the another seller is in default of payment for the leased space.

5. The method of claim 1, wherein acquiring product information of the product using the automatic retail device includes capturing an image of the product using a camera of the automatic retail device.

6. The method of claim 1, wherein acquiring product information of the product using the automatic retail device includes acquiring a weight of the product using a scale of the automatic retail device.

7. The method of claim 1, wherein indicating a location of the leased space in the automatic retail device for stocking the product includes illuminating a bin corresponding to the leased space.

8. The method of claim 1, wherein indicating a location of the leased space in the automatic retail device for stocking the product includes prompting an audible notification identifying the leased space.

9. The method of claim 1, wherein indicating a location of the leased space in the automatic retail device for stocking the product includes prompting a tactile vibration of a bin corresponding to the leased space.

10. The method of claim 1, further comprising reporting stocking event information to a server.

11. The method of claim 1, further comprising authorizing access to the automatic retail device based on the identification information of the seller.

12. The method of claim 1, further comprising determining if an item stocked in the automatic retail device has been removed from the automatic retail device and confirming whether a purchase is desired when it is determined that an item has been removed from the automatic retail device.

13. The method of claim 12, wherein it is determined that an item stocked in the automatic retail device has been removed from the automatic retailed device when a weight of a bin in the automatic retail device is changed after access to the automatic retail device is granted.

14. The method of claim 12, wherein it is determined that an item stocked in the automatic retail device has been removed from the automatic retailed device when an image of a bin in the automatic retail device reveals that an item has been removed from the bin after access to the automatic retail device is granted.

15. The method of claim 1, wherein the leased space include a single bin in the automatic retail device for housing a plurality of products therein.

16. The method of claim 1, wherein the leased space includes a plurality of bins in the automatic retail device, each of the plurality of bins configured to store a single product therein.
